(19) United States
(12) Patent Application Publication
(10) Pub. No.: US 2017/0286932 A1
(43) Pub. Date: Oct. 5, 2017

(54) Method and Electronic Device for Unified Settlement of Online Shopping

(71) Applicants: Le Holdings (Beijing) Co., Ltd., Beijing (CN); Lemall (Beijing) Co., Ltd., Beijing (CN)

(72) Inventors: Tianxiang Zheng, Beijing (CN); Yu Bai, Beijing (CN)

(21) Appl. No.: 15/244,526

(22) Filed: Aug. 23, 2016

Related U.S. Application Data
(63) Continuation of application No. PCT/CN2016/089774, filed on Jul. 12, 2016.

(30) Foreign Application Priority Data
Mar. 30, 2016 (CN) 2016101931141

(51) Int. Cl. G06Q 20/12; G06Q 30/06

(52) U.S. Cl. CPC G06Q 20/123; G06Q 30/0635

(57) ABSTRACT

The present disclosure discloses a method and device for unified settlement of online shopping. The method includes the following steps: a first identification step for identifying a behavior that a user adds a desired virtual commodity into a shopping cart of; a second identification step for identifying a behavior that the user adds a desired physical commodity into the shopping cart; and a settlement step for settling in a unified way the money amount of the a virtual commodity and the physical commodity paid by the user in one time. According to the present disclosure, the commodity settling system of the shopping website can be simplified; an additional novel settling system does not need to be developed for the a virtual commodity; and the labor of workers for maintenance is greatly reduced.

### CROSS REFERENCE TO RELATED APPLICATIONS

This application is a continuation of International Application No. PCT/CN2016/089774, filed Jul. 12, 2016, and claims priority to Chinese Patent Application No. 201610193114.1 filed Mar. 30, 2016, the disclosures of which are hereby incorporated in their entirety by reference.

### TECHNICAL FIELD

The present disclosure relates to the field of online shopping, and particularly relates to a method and electronic device for unified settlement of online shopping.

### BACKGROUND

With the development of Internet network and smart mobile devices, more and more users choose on-line shopping so as to conveniently and rapidly purchase commodities. The users can, through the network mall serving as a network platform, inquire information such as prices and the like of all commodities provided by all merchants stationed in a network mall. At present, more and more network malls appear in the market, for example, Taobao and Alibaba at the beginning, Jingdong Mall, and Letv Mall at present and the like. The competition among the network malls is also increasingly fierce.

With regard to the conventional shopping website, the way of buying a virtual commodity is direct purchase. That is to say, the payment way of a virtual commodity is that the users click to buy and then a settling webpage for payment is directly shown. For example, when a user recharges mobile phone or buys concert tickets in an online mall, the user clicks a “Buy” button and the webpage is directly jumped to a payment page. This buying method avoids a step for adding the commodities to a shopping cart, which seemingly simplifies the buying process to certain extent, but the buying way has serious disadvantages. On one hand, the shopping website needs two sets of payment systems under this payment way, one set of pay system corresponds to direct payment while the other set of payment system corresponds to payment of commodities in the shopping cart, which brings high pressure and burden to the operation cost and maintenance cost of the website. On the other hand, the network users usually choose and buy lots of commodities at one time during online shopping, but the a virtual commodity need to be paid independently, so that the users need to pay twice or more times, which brings inconvenience, and the user experience is seriously affected.

The information disclosed in the Background section only aims to improve the understanding of the overall background of the present disclosure and should not be deemed as admitting or implying in any form that the information constitutes the prior art which has already been known to those of ordinary skill in the art.

### SUMMARY

The purpose of the present disclosure is to provide a method and an electronic device for unified settlement of online shopping where the buying information of a virtual commodity can be put into a shopping cart, so that all the bought commodities can be settled in a unified way via the shopping cart, thus eliminating the trouble of settlement for many times.

The further purpose of the present disclosure is to provide a method and an electronic device for buying a virtual commodity online where a virtual commodity and derivative commodities corresponding to the virtual commodity can be added into the shopping cart, thereby improving the user experience and the operation income of the shopping website.

In order to achieve the above purposes, in one aspect of the present disclosure, a method for unified settlement of online shopping is provided. The method includes the following steps: a first identification step for identifying a behavior that a user adds a desired virtual commodity into a shopping cart; a second identification step for identifying a behavior that the user adds a desired physical commodity into the shopping cart; and a settlement step for settling, in a unified way, money amount of the virtual commodity and the physical commodity paid by the user.

In another aspect of the present disclosure, an electronic device is provided. The electronic device includes: at least one processor; and a memory communicably connected with the at least one processor for storing instructions executable by the at least one processor. Execution of the instructions by the at least one processor causes the at least one processor to: identify a behavior that a user adds a desired virtual commodity into a shopping cart; identify a behavior that the user adds a desired physical commodity into the shopping cart; and settle, in a unified way, money amount of the virtual commodity and the physical commodity paid by the user.

In yet another aspect, a non-transitory computer-readable storage medium is provided. The non-transitory computer-readable storage medium storing executable instructions thereon, which, when executed by an electronic device, cause the electronic device to: identify a behavior that a user adds a desired virtual commodity into a shopping cart; identify a behavior that the user adds a desired physical commodity into the shopping cart; and settle, in a unified way, money amount of the virtual commodity and the physical commodity paid by the user.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a preferred embodiment of a method for unified settlement of online shopping according to the present disclosure.

FIG. 2 is a flow chart of another preferred embodiment of the method for unified settlement of online shopping according to the present disclosure.

FIG. 3 is a flow chart of another preferred embodiment of the method for unified settlement of online shopping according to the present disclosure.

FIG. 4 is a schematic diagram of a device for unified settlement of online shopping according to present disclosure.

FIG. 5 is a structure block diagram of an electronic device capable of implementing a method for unified settlement of online shopping according to the present disclosure.

### DETAILED DESCRIPTION

The specific embodiments of the present disclosure will be described below in detail with reference to the accompanying drawings, but it should be understood that the protection scope of the present disclosure is not limited by the specific embodiments.

Unless otherwise clearly shown, the terms “include” or its variations, such as “comprise” or “has” should be understood as including described components or parts but not excluding other components or other parts.

### Embodiment 1

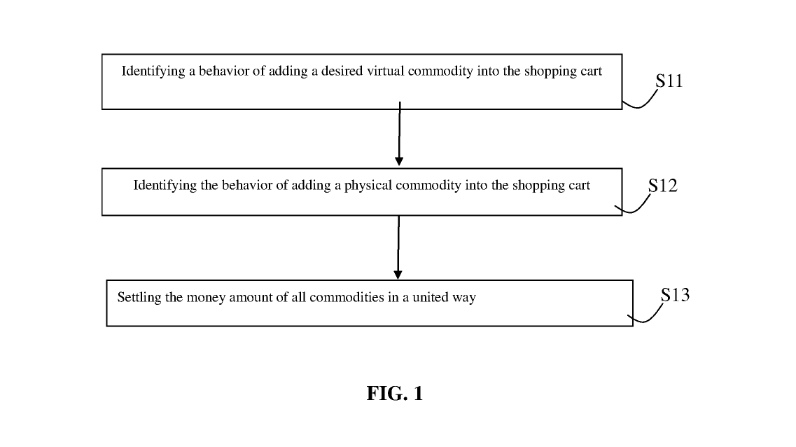

FIG. 1 shows a preferred embodiment of a method for unified settlement of online shopping according to the present disclosure. As shown in FIG. 1, when browsing the shopping website, if a user intends to buy a virtual commodity such as film tickets and member recharge payment and the like, the user can add a virtual commodity into the shopping cart. In the step S11, a server identifies a behavior that the user adds the virtual commodity into the shopping cart. At the same time, the user can buy a physical commodity during browsing the shopping website. In the step S12, the server can identify a behavior that the user adds a physical commodity into the shopping cart. Finally, the user pays all chosen commodities in the shopping cart in one time, and the server settles the money amount of all the virtual and physical commodities in a unified way.

It should be appreciated that the sequence of the steps in the present disclosure need not conform to the sequence set herein, and the step sequence described in the present disclosure is merely for illustration. By taking FIG. 1 as an example, the sequence of step S11 and the step S12 can be exchanged completely without influencing the essence of the present disclosure. Although the embodiment merely shows an example that the user buys two commodities, in fact, the user can add lots of commodities into the shopping cart at his or her will before paying for all the chosen commodities in the shopping cart and then settle them at last in a unified way.

### Embodiment 2

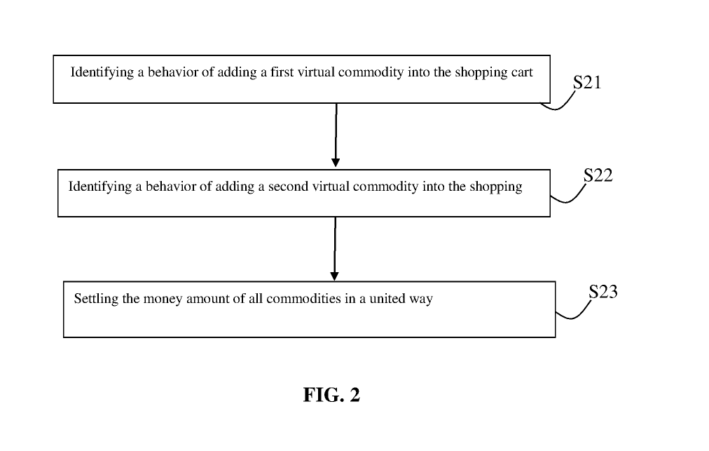

FIG. 2 shows another preferred embodiment of the method for unified settlement of online shopping according to the present disclosure. As shown in FIG. 2, when browsing the shopping website, if a user intends to buy a virtual commodity such as film tickets and member recharge payment and the like, the user can add a virtual commodity into the shopping cart. In the step S21, the server can identify a behavior that a user adds a virtual commodity into the shopping cart. At this time, different from the Embodiment 1, the user may still choose and buy another virtual commodity (for example, mobile phone virtual recharge card) during browsing the shopping website. In the step S22, the server identifies a behavior that a user adds the other virtual commodity into the shopping cart. Finally, the user pays lots of chosen commodities in the shopping cart at a time; the server settles the money amount of all the virtual commodities in a unified way in the step S23.

The embodiment merely explain the method for settling two virtual commodities in the shopping cart in a unified way. It should be appreciated that lots of a virtual commodity and/or a physical commodity can be added into the shopping cart.

### Embodiment 3

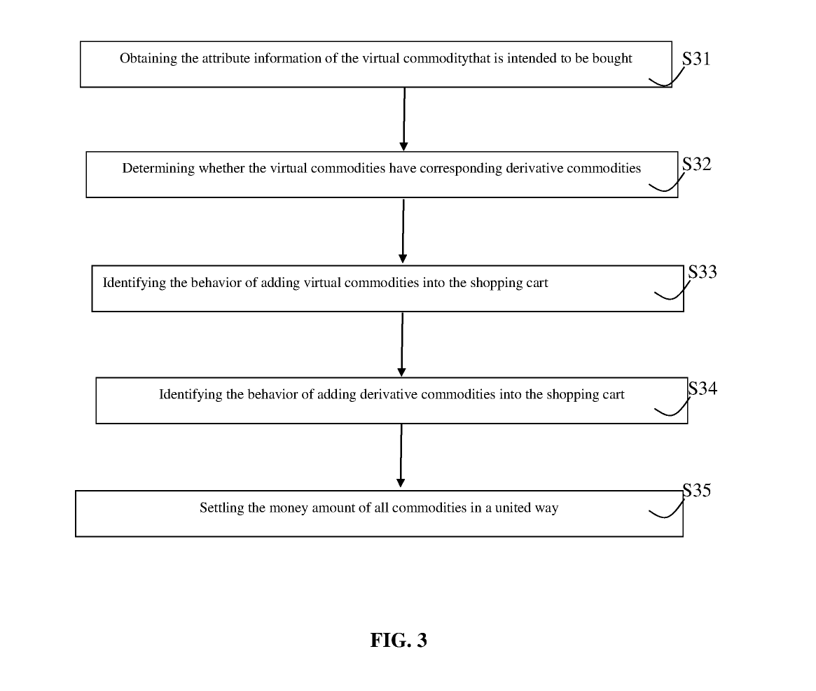

FIG. 3 shows another embodiment of the method for unified settlement of online shopping according to the present disclosure. As shown in FIG. 3, during browsing the shopping website, if the user intends to buy a virtual commodity on a website, the attribute information of the virtual commodity is chosen. For example, the attribute information of the film tickets includes price, quantity of the ticket, film playing time, screening schedule and a specific cinema. In the step S31, the server obtains the attribute information of the desired virtual commodity. In the step S32, the server determines whether the virtual commodity has corresponding derivative commodities according to the attribute information. Then, according to the method of the present disclosure, after the user chooses a wanted virtual commodity, the virtual commodity is added into the shopping cart. In the step S33, the server can identify a behavior of adding the virtual commodity into the shopping cart. As the virtual commodity can have lots of derivative commodities, lots of derivative commodities associated with the film ticket can be displayed on the description page of the film ticket; the user can directly add the derivative commodities into the shopping cart or click on the links of the derivative commodities to enter the description page of the derivative commodity, and then add the derivative commodities into the shopping cart. Optionally, a system pops up the description information of the derivative commodities after or during choosing the attribute information such as screening number, seat No. and the like of the a virtual commodity; the user can click on the links of the derivative commodities at this moment in the step S34 or directly add the derivative commodities into the shopping cart. Then, the user pays the a virtual commodity and the derivative commodities thereof in the shopping cart at a time. In the step S35, the server charges and settles the payment so as to complete the whole process of buying the virtual commodity and the derivative commodities.

Preferably, in the embodiment, the method includes the following steps: determining whether the a virtual commodity have corresponding derivative commodities according to the attribute information; and displaying the information of the derivative commodities on the webpage used for selling the a virtual commodity. The attribute information includes one or more of the following attributes: the merchant information, name, content, quantity and price of the virtual commodity. The derivative commodities may be at least one of foods, dolls or mascots corresponding to the characters of the films.

Preferably, in the embodiment, the method further includes the following steps: pre-storing a corresponding relationship between a virtual commodity and the corresponding derivative commodities; and determining whether the virtual commodity has corresponding derivative commodities according to the corresponding relationship.

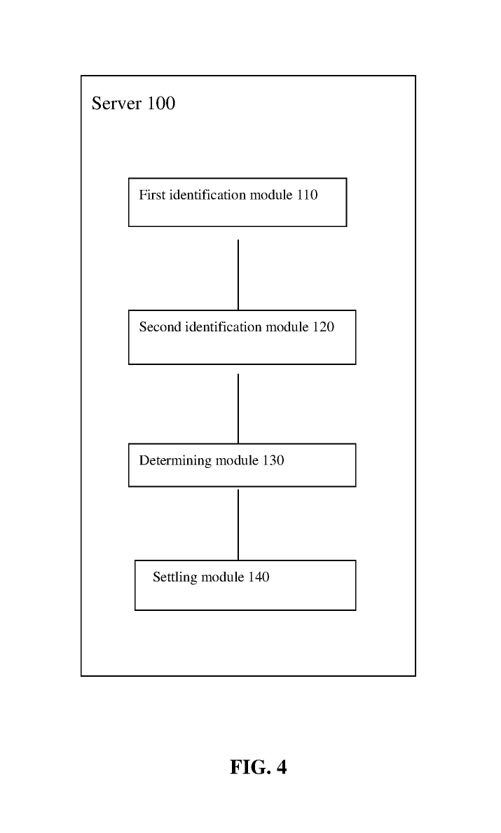

FIG. 4 is a schematic diagram of a device for buying a virtual commodity online according to the present disclosure. The server 100 of the shopping website includes a first identification module 110 for identifying a behavior that a user adds a virtual commodity that he wants to buy into the shopping cart, a second identification module 120 for identifying a behavior that the user adds a physical commodity he wants to buy into the shopping cart, and a settling module 140 for settling in a unified way the money amount of the a virtual commodity and the a physical commodity paid by the user at one time.

It should be illustrated that the first identification module 110 and the second identification module 120 maybe the same or different, even maybe the identical module.

In a variant of the embodiment as shown in FIG. 4, the device for unified settlement of online shopping includes a first identification module 110 for identifying a behavior of adding a first virtual commodity into a shopping cart of, a second identification module 120 for identifying a behavior of adding a second virtual commodity into the shopping cart, and a settling module 140 for settling in a unified way the money amount of the first commodity and the second commodity paid by the user.

Preferably, the server also includes a determining module 130 for determining whether the virtual commodity have corresponding derivative commodities according to the attribute information of the virtual commodity.

The working manners of the modules have been described in detail in Embodiment 1-3 and are not described here again.

In conclusion, according to the method for buying a virtual commodity online, the a virtual commodity to be bought are put into the shopping cart and then settled, so that the commodity settling system of the shopping website can be simplified; an additional novel settling system does need to be developed for the a virtual commodity; and the labor of workers for background maintenance is greatly reduced. Secondly, according to the method for buying a virtual commodity online of the present disclosure, the derivative commodities associated with the a virtual commodity can also be chosen and bought during buying the a virtual commodity, so that the operation income of the shopping website is greatly increased; meanwhile, the user can settling the a virtual commodity and the derivative commodities at a time; the shopping of the user is facilitated.

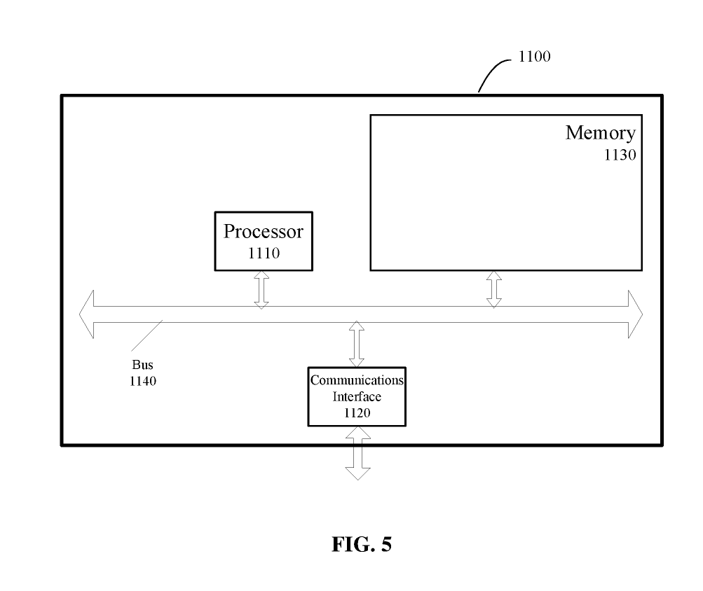

FIG. 5 is a structure block diagram of an electronic device capable of implementing a method for unified settlement of online shopping according to the present disclosure. The electronic device 100 maybe a host server, a personal computer PC or a portable computer or a terminal with calculating capability. The specific embodiments of the present disclosure are not used for limiting the specific implementations of computing nodes.

The electronic device 1100 includes a processor 110, a communications interface 1120, a memory (memory array) 130 and a bus 1140, wherein the processor 1110, the communications interface 1120 and the memory 1130 are intercommunicated via the bus 1140.

The communications interface 1120 communicates with network elements including a virtual machine management center and a shared memory and the like.

The processor 1110 is used for executing programs. The processor 1110 maybe a central processing unit (CPU), an ASIC (Application Specific Integrated Circuit) or one or more integrated circuits configured for implementing the embodiments of the present disclosure.

The memory 1130 is used for storing files. The memory 1130 may include a high-speed RAM memory and also may include a non-volatile memory, for example, at least one disk memory. The memory 1130 may also be a memory array. The memory 1130 may also be divied into blocks; and the blocks are combined to be a virtual volume according to a certain rule.

In a possible embodiment, the programs may be program codes including computer operation instructions. Such computer operation instructions can be stored in a non-transitory computer-readable storage medium. The computer operation instructions can be executed by a processor or by an electronic device including a processor. Execution of the instructions by the processor can cause the processor or can cause the electronic device to: identify a behavior that a user adds a desired virtual commodity into a shopping cart; identify a behavior that the user adds a desired physical commodity into the shopping cart; and settle, in a unified way, money amount of the virtual commodity and the physical commodity paid by the user.

In a possible embodiment, execution of the instructions by the processor further causes the processor or the electronic device to: further identify a behavior that the user adds other virtual commodity and/or physical commodity into the shopping cart, before the settlement.

In a possible embodiment, execution of the instructions by the processor further causes the processor or the electronic device to: determine whether the virtual commodity has corresponding derivative commodities according to the attribute information of the virtual commodity; and display the information of the derivative commodities on a same webpage as the one used for selling the virtual commodity.

Those skilled in the art should understand that the embodiments of the present disclosure can be provided as a method, a system or a computer program product. Therefore, the present disclosure can adopt forms of hardware embodiments, software embodiments or embodiments with combination of software and hardware. Meanwhile, the present disclosure can adopt forms of computer program products implemented on one or more computer available memory media (including but not limited to disk memories and optical memories and the like) including computer available program codes.

It should be understood that in the device and/or method of the present disclosure, the steps can be successively performed according to the sequence described in the specification; furthermore, as long as the same or equivalent technical effect can be achieved, the steps can be performed in parallel or independently.

The above description of the specific exemplary embodiments is only for the purposes of illustration and exemplification. The description is not intended to define the present disclosure as the disclosed precise forms; apparently, lots of changes and variations can be performed according to the teaching. The purpose of selecting and describing the exemplary embodiments is to explain the specific principles and the practical application of the present disclosure, so that those skilled in the art can implement and use various different exemplary embodiments and various different selections and changes of the present disclosure. The scope of the present disclosure can be defined by claims and its equivalent forms.

What is claimed is:

1. A method for unified settlement of online shopping, adapted to be used by a server, said method comprising:
a first identification step for identifying a behavior that a user adds a desired virtual commodity into a shopping cart;
a second identification step for identifying a behavior that the user adds a desired physical commodity into the shopping cart; and
a settlement step for settling, in a unified way, money amount of the virtual commodity and the physical commodity paid by the user.

2. The method according to claim 1, further comprising:
further identifying a behavior that the user adds other virtual commodity and/or physical commodity into the shopping cart, before the settlement step.

3. The method according to claim 1, further comprising:
determining whether the virtual commodity has corresponding derivative commodities according to the attribute information of the virtual commodity; and
displaying the information of the derivative commodities on a same webpage as the one used for selling the virtual commodity.

4. The method according to claim 3, wherein the attribute information comprises at least one of the following: merchant information, name, content, quantity, and price of the virtual commodity.

5. An electronic device, comprising:
at least one processor; and
a memory communicably connected with the at least one processor for storing instructions executable by the at least one processor, wherein execution of the instructions by the at least one processor causes the at least one processor to:
identify a behavior that a user adds a desired virtual commodity into a shopping cart;
identify a behavior that the user adds a desired physical commodity into the shopping cart; and
settle, in a unified way, money amount of the virtual commodity and the physical commodity paid by the user.

6. The electronic device according to claim 5, wherein execution of the instructions by the at least one processor further causes the at least one processor to:
further identify a behavior that the user adds other virtual commodity and/or physical commodity into the shopping cart, before the settlement.

7. The electronic device according to claim 5, wherein execution of the instructions by the at least one processor further causes the at least one processor to:
determine whether the virtual commodity has corresponding derivative commodities according to the attribute information of the virtual commodity; and
display the information of the derivative commodities on a same webpage as the one used for selling the virtual commodity.

8. The electronic device according to claim 7, wherein the attribute information comprises at least one of the following: merchant information, name, content, quantity, and price of the virtual commodity.

9. A non-transitory computer-readable storage medium storing executable instructions thereon, which, when executed by an electronic device, cause the electronic device to:
identify a behavior that a user adds a desired virtual commodity into a shopping cart;
identify a behavior that the user adds a desired physical commodity into the shopping cart; and
settle, in a unified way, money amount of the virtual commodity and the physical commodity paid by the user.

10. The non-transitory computer-readable storage medium according to claim 9, wherein execution of the instructions further causes the electronic device to:
further identify a behavior that the user adds other virtual commodity and/or physical commodity into the shopping cart, before the settlement.

11. The non-transitory computer-readable storage medium according to claim 9, wherein execution of the instructions further causes the electronic device to:
determine whether the virtual commodity has corresponding derivative commodities according to the attribute information of the virtual commodity; and
display the information of the derivative commodities on a same webpage as the one used for selling the virtual commodity.

12. The non-transitory computer-readable storage medium according to claim 11, wherein the attribute information comprises at least one of the following: merchant information, name, content, quantity, and price of the virtual commodity.
